(19) United States
(12) Patent Application Publication
(10) Pub. No.: US 2023/0319633 A1
(43) Pub. Date: Oct. 5, 2023

(54) STEERING FRAGMENTATION OF DATA PACKETS ON DATA COMMUNICATION NETWORKS BASED ON DATA PACKET SIZE

(71) Applicant: Fortinet, Inc., Sunnyvale, CA (US)

(72) Inventors: PC Sridhar, Bangalore (IN); Pradeep Mohan, Bangalore (IN); Mohan Jayaraman, Bangalore (IN)

(21) Appl. No.: 17/710,781

(22) Filed: Mar. 31, 2022

(51) Int. Cl. H04W 28/06; H04W 76/12

(52) U.S. Cl. CPC H04W 28/065; H04W 76/12; H04W 84/12

(57) ABSTRACT

When a data packet too big frame is received from the access point, activating fragmentation at the station. The data packet too big frame is responsive to a data packet being sent from the station to the access point and then being rejected as too big when sent from the access point to a network device due to the data packet being too large for processing by the network device. The fragmentation activated at the station and configured based on a maximum data packet size allowed by the network device.

### FIELD OF THE INVENTION

The invention relates generally to computer networking, and more specifically, for steering fragmentation of IPv6 data packets based on data packet size.

### BACKGROUND

FIG. 1 displays an IPv6 Wi-Fi network consisting of a wireless controller 110 at the head office and access point 120 at a remote location across a WAN network. Station 130 is associated to the Wi-Fi network and has an IPv6 address to communicate on the network. A file server 150 with its own IPv6 address is located at the head office.

When station 130 with IPv6 address 2001::1 pings the file server 150, with packet length of 1400 bytes, with IP address 2002::10, the packet which reaches the access point 120 is then encapsulated with the source now being the access point 120 and not the station 130.

The packet then reaches router 140 eth0 interface and gets routed via the eth1 port and reaches router 140 eth1 interface. The MTU size on eth0 interface of router 140 is set to the minimum of 1280 bytes which means the packet cannot be transmitted out of the eth0 interface of router 140. In turn, router 140 sends a “Packet Too Big” in response to the packet. Since access point 120 is now the source of the packet, when the access point 120 receives the Packet Too Big, it then fragments the packet and transmits the fragments. This leads to more processing on the access point 120 since it also involves the fragmentation module which can affect the access point 120 performance if there are many large packets to be fragmented on the network.

Therefore, what is needed is a robust technique for steering fragmentation of IPv6 data packets based on data packet size to an original source, or to an alternative source.

### SUMMARY

These shortcomings are addressed by the present disclosure of methods, computer program products, and systems for steering fragmentation of IPv6 data packets based on data packet size.

In one embodiment, an access point module manages a plurality of access points over the data communication network. A CAPWAP (Control and Provisioning of Wireless Access Points) module maintains a CAPWAP tunnel between the Wi-Fi controller and an access point from the plurality of access points. A station module can manage a plurality of stations connected to the plurality of access points. A fragmentation module configures a station from the plurality of stations for fragmentation.

In yet another embodiment, when a data packet too big frame is received from the access point, activating fragmentation at the station. The data packet too big frame is responsive to a data packet being sent from the station to the access point and then being rejected as too big when sent from the access point to a network device due to the data packet being too large for processing by the network device. The fragmentation activated at the station and configured based on a maximum data packet size allowed by the network device.

Advantageously, network performance is improved, and access point computing devices operate more efficiently, with less processing congestion.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a block diagram illustrating a prior art system for default fragmentation of IPv6 data packets.

FIG. 2 is a block diagram illustrating system for steering fragmentation of IPv6 data packets based on data packet size, according to an embodiment.

FIGS. 3A-3C is a more detailed block diagram illustrating a Wi-Fi controller of the system of FIG. 1, according to an embodiment.

FIG. 4 is a high-level flow diagram illustrating a method for steering fragmentation of IPv6 data packets based on data packet size, according to one preferred embodiment.

FIG. 5 is a more detailed flow diagram illustrating the step of moving fragmentation from the access point a station responsive to a data packet too big frame for the method of FIG. 4, according to one embodiment.

FIG. 6 is a high-level block diagram illustrating a computing device as an example hardware implementation of network devices herein, according to an embodiment.

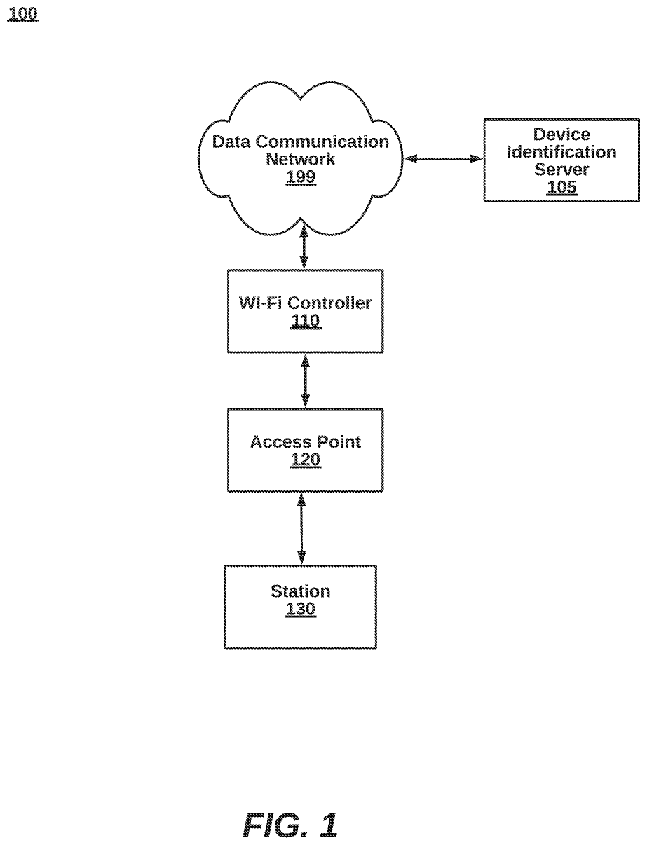

### DETAILED DESCRIPTION

The description below provides methods, computer program products, and systems for steering fragmentation of IPv6 data packets based on data packet size.

One of ordinary skill in the art will recognize many additional variations made possible by the succinct description of techniques below.

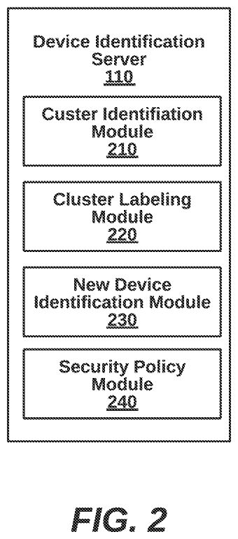

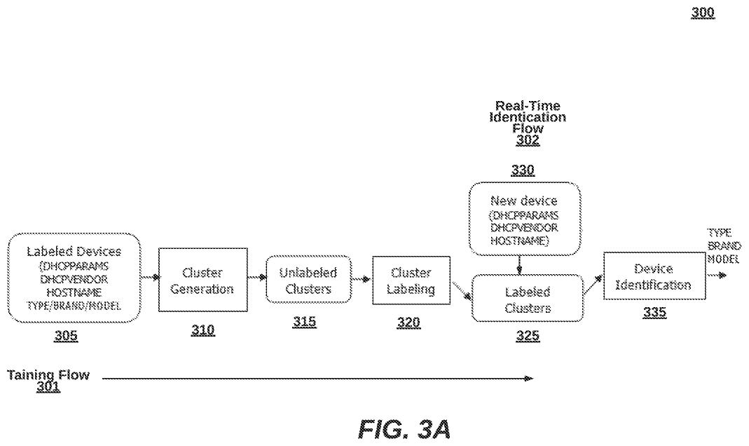

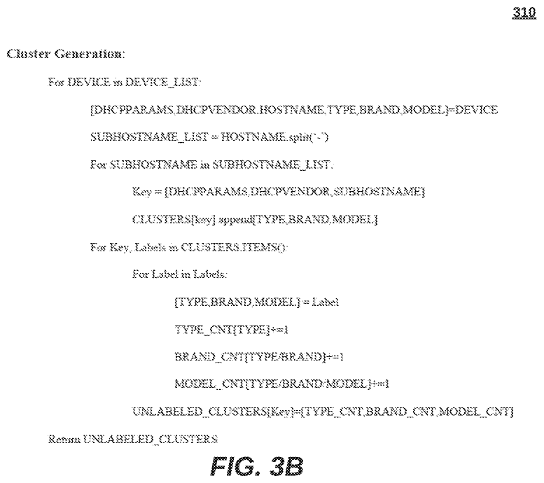

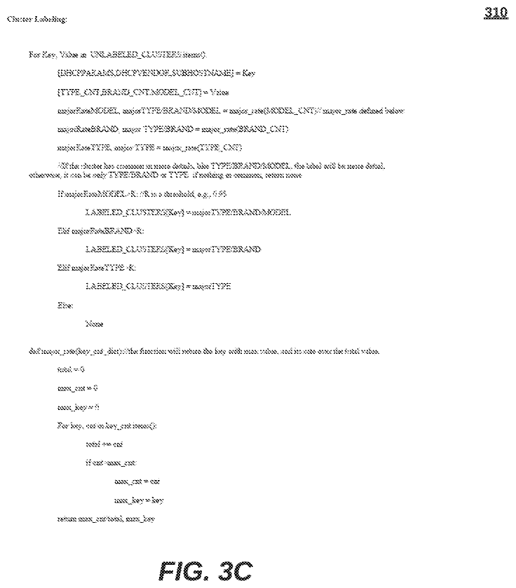

I. Systems for IPv6 Fragmentation Steering (FIGS. 2-3)

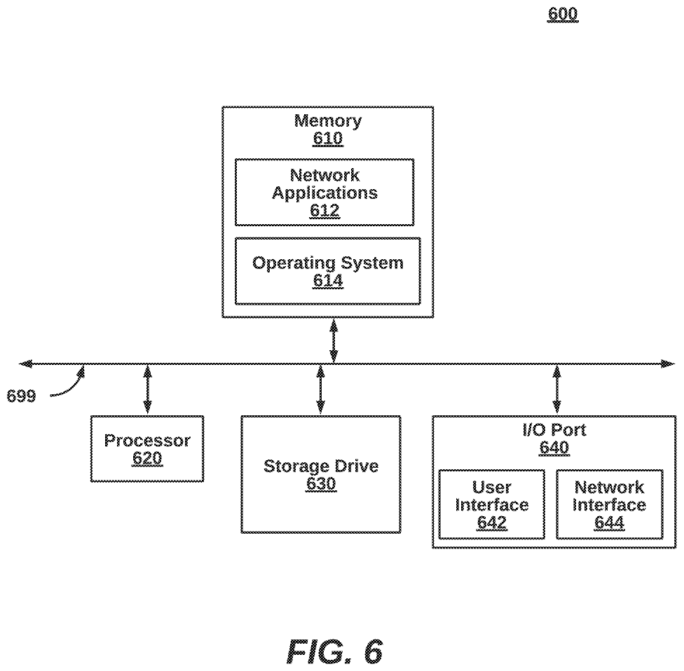

FIG. 2 is a block diagram illustrating a system 200 for steering fragmentation of IPv6 data packets based on data packet size, according to an embodiment. The system 200 includes a network device 240, a Wi-Fi controller 210, an access point 220, and a station 230, coupled to a data communication network 299. Many other configurations are possible, for example, with additional network components such routers, switches, repeaters, firewalls, and the like. Also, there can be many more or fewer clients than shown in FIG. 2. In one alternative embodiment, another level of retransmission occurs from stations on a mesh network downstream from the station 130 or from IoT devices connected to the station 130 by Bluetooth or other mechanisms. The system components can be implemented in computer devices with non-transitory source code, such as set forth below with reference to FIG. 6.

The components of the system 200 are coupled in communication over the data communication network. The components can be connected to the data communication system via hard wire. The data communication network 299 can be any data communication network such as an SDWAN, an SDN (Software Defined Network), WAN, a LAN, WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, and the like.

The Wi-Fi controller 210 steers fragmentation of data packets from the access point 220 to the station 230. Responsive to a data too large notification via data frame or other mechanism, fragmentation is activated at the station 230 by sending a maximum data packet size (or maximum MTU, maximum transmission unit, size) to the station 230. In one case, the maximum data packet size is based on other network-wide factors to set a maximum lower than the maximum MTU size. One implementation steers fragmentation even further downstream from the station 130, to Bluetooth connected devices, or mesh devices, for example.

The data packet too big frame, in an embodiment, is responsive to a data packet being sent from the station 230 to the access point 220, and then being rejected as too big when sent from the access point 220 to the network device 240 due to the data packet being too large for processing by the network device 240. The fragmentation activated at the station 230 and configured based on a maximum data packet size allowed by the network device 240. In one example, the data too large packet comprises an Internet Control Message Protocol for IPv6(ICMPv6) formatted too big frame.

More generally, the Wi-Fi controller 210 has network wide access to data and conditions aggregated by a group of access points. Stations can be tracked as they enter at one point and travel from access point to access point. Network wide policies can be implemented from this hierarchical control point.

In one embodiment, the access point 220 provides backhaul access to a wide area network for the station 230 and other stations on a private network. After processing by the access point 220, data packets can be forwarded to a network device, such as a router, a switch, a gateway or a firewall. This next hop is limited by an MTU or other max, and in turn, enforces the same limitation on the access point 220. When a data packet exceeds the limit, a packet too large notification is sent to the access point 220 from the network device 240. Next, the packet too large notification (or derivative) is sent from the access point 220 to the Wi-Fi controller 210.

The station 230 fragments data packets locally, prior to sending to the access point 220. For example, a 1400 bytes packet, routed through a 1280 bytes limitation is concatenated into two or more data packets. One data packet can be 1280 bytes and the other data packet any leftover amount, 120 bytes in this case. Alternatively, the data packets can be constructed equally with 640 bytes of content.

FIG. 3 is a more detailed block diagram illustrating the Wi-Fi controller 210 of the system of FIG. 2, according to an embodiment. The Wi-Fi controller 210 includes an access point module to manage 310, a CAPWAP module 320, a station module 330, a fragmentation module 340. The modules can be implemented in source code stored in non-transitory memory executed by a processor. Alternatively, the modules can be implemented in hardware with microcode. The modules can be singular or representative of functionality spread over multiple components. Many other variations are possible.

The access point module 310 manages a plurality of access points over the data communication network. A table for which SSIDs are assigned to access points can be generated and updated. Each MAC address can also stored for communications. In one embodiment, the access point module 310 uploads local status data to the Wi-Fi controller 210. For example, throughput, queue load, processor load, ambient temperature, ambient humidity, and other data.

The CAPWAP module 320 to maintain a CAPWAP tunnel between the Wi-Fi controller 210 and the access point 220 from the plurality of access points. In general, CAPWAP is a protocol that is a standard for wireless controllers centrally managing access points. Other protocols can also be substituted. Once a CAPWAP tunnel is negotiated with the access point 220 and other access points, control messages can be easily passed. In one embodiment, a packet too large notification is received as one or more frames over the CAPWAP module 220.

The station module 330 manages a plurality of stations connected to the plurality of access points. An operating system on stations provide a communication channel with the station 230 and other stations. Also, an application or a daemon running on the operating system can establish the same. In one embodiment, a packet too large notification is sent as one or more frames in a format that is implementation-specific.

The fragmentation module 240 configures the station 230 for fragmentation. When a data packet too big frame is received from the access point, the fragmentation module 240 activates fragmentation at the station 230.

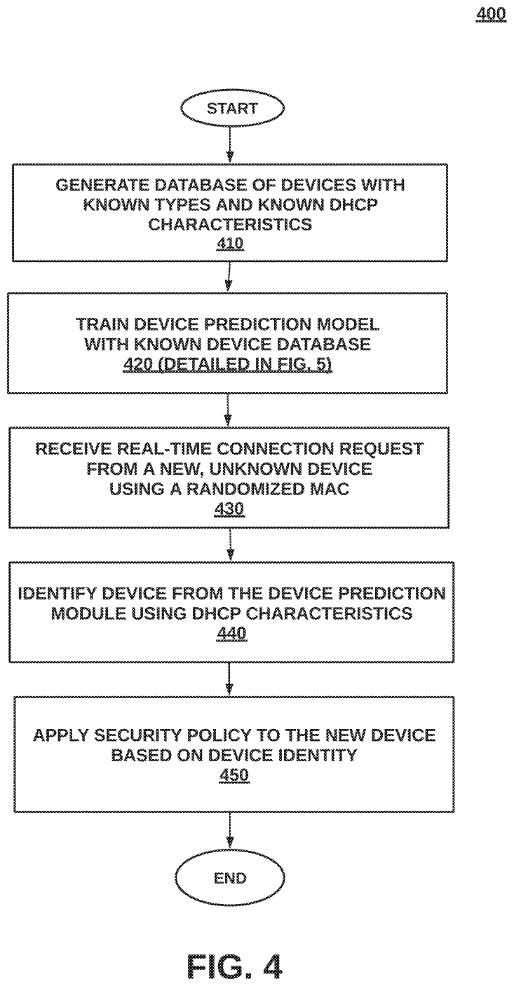

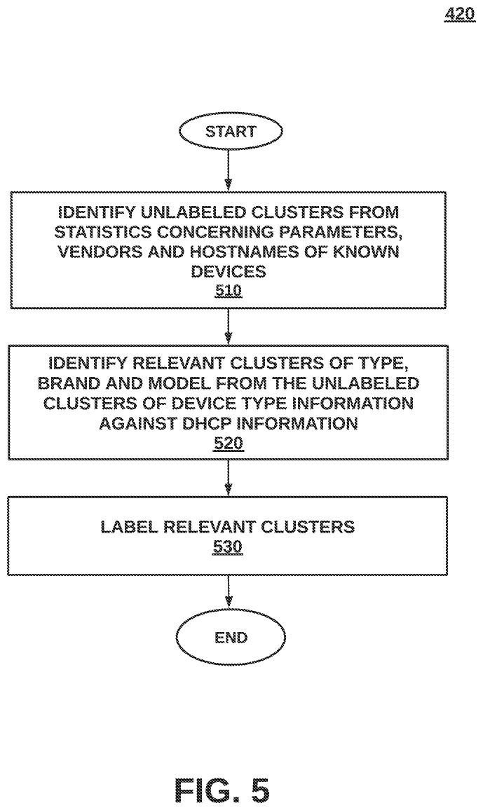

II. Methods for IPv6 Fragmentation Steering (FIGS. 4-5)

FIG. 4 is a high-level flow diagram illustrating a method for steering fragmentation of IPv6 data packets based on data packet size, according to one preferred embodiment. The method 400 can be implemented, for example, by the system 100. The steps are merely representative groupings of functionality, as there can be more or fewer steps, and the steps can be performed in different orders. Many other variations of the method 400 are possible.

First, communication channels are established. At step 410, a plurality of access points is managed by a Wi-Fi controller over the data communication network. At step 420, a CAPWAP tunnel is maintained between the Wi-Fi controller and an access point from the plurality of access points. At step 430, a plurality of stations connected to the plurality of access points are managed by the access point.

Then real-time network traffic sessions of data packets are processed, at step 440. At step 450, fragmentation is moved from the access point to the station, as discussed in further below in reference to FIG. 5. At step 460, the station sends subsequent data packets that have already been fragmented prior to transmission.

In FIG. 5 the fragmentation move step 440 of the method 400 is detailed. At step 510, data packets are sent from the station to the access point upstream to a backhaul network. At step 520, when a data packet triggers a too big frame by an upstream device (e.g., a router, a gateway, or a controller), notification is sent from a network device having an MTU exceeded by the data packet, at step 530. At step 540, a data packet too big notification can be sent from the access point to a Wi-Fi controller. The notifications can be identical, the first notification can be embedded in the second notifications, or notifications can be different. As a result, fragmentation at the station is activated, at step 550, by sending a data packet too big to the station. In one embodiment, fragmentation activation includes sending MTU data and routing information to the station for local configuration of local fragmentation at the station. Some embodiments share fragmentation tasks cooperatively between the access point and the station to partially offload from the access point.

III. Generic Computing Environment

FIG. 6 is a block diagram illustrating a computing device 600 capable of implementing components of the system, according to an embodiment. The computing device 600 of the present embodiment, includes a memory 610, a processor 620, a storage drive 630, and an I/O port 640. Each of the components is coupled for electronic communication via a bus 699. Communication can be digital and/or analog and use any suitable protocol. The computing device 600 can be any of components of the system 100 (e.g., Wi-Fi controller 110, access point 120, and station 130), other networking devices (e.g., an access point, a firewall device, a gateway, a router, or a wireless station), or a disconnected device.

Network applications 612 can be network browsers, daemons communicating with other network devices, network protocol software, and the like. An operating system 614 within the computing device 600 executes software, processes. Standard components of the real OS environment 614 include an API module, a process list, a hardware information module, a firmware information module, and a file system. The operating system 614 can be FORTIOS, one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The storage drive 630 can be any non-volatile type of storage such as a magnetic disc, EEPROM (electronically erasable programmable read-only memory), Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g., an RF antennae) connects to a medium such as Ethernet or Wi-Fi for data input and output. Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A Wi-Fi controller communicatively coupled to a data communication network with a Wi-Fi portion having a plurality of stations, for steering fragmentation of IPv6 data packets based on packet size, the Wi-Fi controller comprising:
a processor;
a network interface communicatively coupled to the processor and communicatively coupled to exchange data packets over the data communication network; and
a memory communicatively coupled to the processor and storing:
an access point module to manage a plurality of access points over the data communication network;
a CAPWAP (Control and Provisioning of Wireless Access Points) module to maintain a CAPWAP tunnel between the Wi-Fi controller and an access point from the plurality of access points;
a station module to manage a plurality of stations connected to the plurality of access points; and
a fragmentation module to configure a station from the plurality of stations for fragmentation, and when a data packet too big frame is received from the access point, activating fragmentation at the station,
wherein the data packet too big frame is responsive to a data packet being sent from the station to the access point and then being rejected as too big when sent from the access point to a network device due to the data packet being too large for processing by the network device, and
wherein the fragmentation activated at the station and configured based on a maximum data packet size allowed by the network device.

2. The Wi-Fi controller of claim 1, wherein the maximum data packet size is based on an MTU allowed by the network device.

3. The Wi-Fi controller of claim 1, wherein the CAPWAP module receives a packet too big frame the access point over the CAPWAP tunnel.

4. A method in an access point communicatively coupled to a data communication network, for steering fragmentation of IPv6 data packets based on packet size, the method comprising the steps of:
managing a plurality of access points over the data communication network;
maintaining a CAPWAP tunnel between the Wi-Fi controller and an access point from the plurality of access points;
managing a plurality of stations connected to the plurality of access points; and
configuring a station from the plurality of stations for fragmentation, and when a data packet too big frame is received from the access point, activating fragmentation at the station,
wherein the data packet too big frame is responsive to a data packet being sent from the station to the access point and then being rejected as too big when sent from the access point to a network device due to the data packet being too large for processing by the network device, and
wherein the fragmentation activated at the station and configured based on a maximum data packet size allowed by the network device.

5. The method of claim 4, wherein the maximum data packet size is based on an MTU allowed by the network device.

6. The method of claim 4, wherein the CAPWAP module receives a packet too big frame the access point over the CAPWAP tunnel.

7. A non-transitory computer-readable media in an access point communicatively coupled to a data communication network, for steering fragmentation of IPv6 data packets based on packet size, the method comprising the steps of:
aging a plurality of access points over the data communication network;
maintaining a CAPWAP tunnel between the Wi-Fi controller and an access point from the plurality of access points;
managing a plurality of stations connected to the plurality of access points; and
configuring a station from the plurality of stations for fragmentation, and when a data packet too big frame is received from the access point, activating fragmentation at the station,
wherein the data packet too big frame is responsive to a data packet being sent from the station to the access point and then being rejected as too big when sent from the access point to a network device due to the data packet being too large for processing by the network device, and
wherein the fragmentation activated at the station and configured based on a maximum data packet size allowed by the network device.

8. The method of claim 7, wherein the maximum data packet size is based on an MTU allowed by the network device.

9. The method of claim 7, wherein the CAPWAP module receives a packet too big frame the access point over the CAPWAP tunnel.
